(19) United States
(12) Patent Application Publication
(10) Pub. No.: US 2007/0294850 A1
(43) Pub. Date: Dec. 27, 2007

(54) Spatula tool system

(75) Inventors: Warren L. Murphy, Jacksonville, OR (US); Eric S. Foy, Medford, OR (US)

Correspondence Address: ROBERT D. VARITZ, P.C., 4915 SE 33RD PLACE, PORTLAND, OR, 97202, US

(73) Assignee: Warren L. Murphy

(21) Appl. No.: 11/473,350

(22) Filed: Jun. 22, 2006

(51) Int. Cl. B05C 17/10

(52) U.S. Cl. 15/235.4; 15/236.01

(57) ABSTRACT

A component spatula tool system including an elongate grip handle structure, and a generally planar blade which is releasably grippable by the handle structure. The handle structure has a pair of opposed, selectively openable and closeable, matchingly grip-patterned clamping pads that define a nip region, the blade has opposite sides possessing matchingly grip-patterned clamping sites whose grip patterns are complementary to those of the clamping pads, and the clamping pads and clamping sites accommodate, via operative interengagements of their respective grip-patterned characteristics, positive-lock, universally invertible, plural-position clamp locking of the blade within the nip region.

### BACKGROUND AND SUMMARY OF THE INVENTION

This invention pertains to a spatula tool system, and in particular to a spatula-tool component system which features selective connection and disconnection of certain system elements. The invention is illustrated herein in the context specifically of a system which is useable during building construction by workers who apply so-called tape-and-mud over the joints and other surface areas of internal wallboard material which is affixed to building frame structure. The invention is particularly illustrated and described in such a “taping mud” environment for the reason that this environment has been one wherein the features of the invention have been found to offer particular utility. It should be understood, however, that the characteristics of the present invention may also have applicability in other useful areas wherein a spatula-like tool is to be used.

As those who practice in what may be referred to as the wallboard installation aspect of building construction will know, there are many instances where it is desirable to have differently shaped and configured spatula tools useable to apply the so-called plaster-like mud to a wallboard installation. For example, there are instances wherein it may be desired to have tools of different sizes, i.e., different blade and handle sizes, and other instances wherein it may be desired that a blade and a handle have, effectively, different lateral offsets relative to one another. To accommodate these considerations in the practice of the prior art, it has essentially been necessary for a worker to have one each of the different kinds of spatula tools that may be needed.

The present invention addresses this consideration in a unique, and somewhat modular, fashion, by proposing a connectable/disconnectable, component spatula tool system including a generally pincers-action, articulated handle structure having clamping pads that can be opened and closed relative to one another on opposite sides of a nip region to receive, and then lockably to grip (for later release), a spatula blade (referred to as a “knife” in the “taping mud” field of art). With such a system, a worker need only possess very few components in order quickly and versatilely to “create” specifically shaped and sized spatula tools that are best suited for a particular construction activity. For example, with two or three handle structures (of the type just generally mentioned) possessing different overall lengths, and with just a very few different-lateral-length (i.e., width) blades which can couple releasably with these handle structures, a worker is offered a very versatile package of component spatula tools that can be assembled on the job differently to accommodate different use requirements.

Preferably, the tool system of the present invention is made up of just a few relatively simple molded-plastic components which are precision-molded to enhance simple, precision locking and unlocking of the basic system components to create spatula tools having different configurations and uses.

The various specific features and advantages that are offered by the present invention will become more fully apparent as the description which follows below is read in conjunction with the accompanying drawings.

### DESCRIPTION OF THE DRAWINGS

FIG. 1 is a simplified, high-level, schematic, generally isometric view of the component spatula tool system of the present invention.

FIG. 2 is an isometric view, with considerably more detail shown, of the system pictured in FIG. 1.

FIG. 3 is a plan view of the tool system shown in FIG. 2.

FIG. 4 is a view taken generally along line 4-4 in FIG. 3.

FIG. 5 is similar to FIG. 2, except that it illustrates an open condition existing between a pair of clamping pads which form part of an articulated handle structure included in the system of FIGS. 1-4, inclusive.

FIG. 6 is a view taken generally along the line 6-6 in FIG. 5.

FIG. 7 is a plan view illustrating one form of a spatula blade made in accordance with the present invention.

FIG. 8 is a simplified, isolated plan view of one of two duplicate-shape handle components included in the system of FIGS. 1-6, inclusive. This handle component is illustrated with a greater length than that of each of the matching the handle components in the handle structure pictured in FIGS. 2-6, inclusive.

FIG. 9 is a plan view of a modified (laterally lengthened) embodiment of a spatula blade which is somewhat like the blade shown in FIG. 7.

FIG. 10 is a view very much like that presented in FIG. 3, except that it shows a spatula blade shifted laterally in its position relative to handle structure in the system of the invention.

FIG. 11 is a fragmentary plan view presented on a larger scale than those employed in FIGS. 1-10, inclusive, illustrating, with portions broken away, special grip patterning which is provided in clamping pads in accordance with practice of the present invention.

FIG. 12 is a still larger-scale, fragmentary, isometric view of the patterned clamping pad which is shown in plan view in FIG. 11.

### DETAILED DESCRIPTION OF THE INVENTION

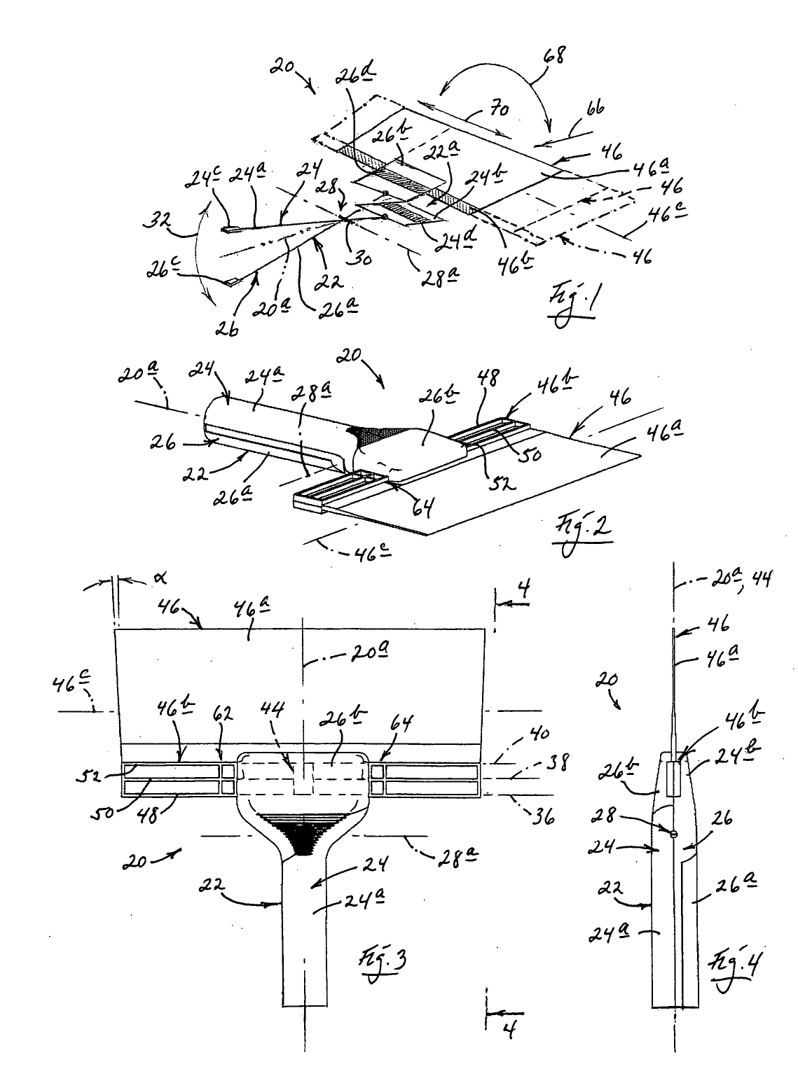

Beginning with a discussion which relates to each of FIGS. 1-8, inclusive, 11, and 12, a component spatula tool system featuring selective connectability and disconnectability of certain system components is shown generally at 20. This system includes an elongate, articulated, pincers-action handle structure 22 formed by two, elongate, matching-configuration (duplicate-shape) handle components 24, 26 which are molded of a suitable plastic material, such as ABS plastic material. Handle components 24, 26 are pivoted at 28, in reversely disposed relative positions, by an appropriately installed pivot pin 30. Pin 30 accommodates selective counter-rotation, as indicated by double-headed, curved arrow 32, about an axis 28a which extends substantially normally relative to the long axis of system 20 shown by dash-double-dot line 20a. Axis 20a is coincident herein with what is referred to as being the long axis of handle structure 22.

Handle components 24, 26 include (a) elongate handle portions 24a, 26a, respectively, (b) special, three-dimensionally patterned, integral clamping pads 24b, 26b, respectively, (collectively called positive-lock clamping structure) located adjacent one set of ends of handle portions 24a, 26a, (c) appropriate, reversibly snap-together, cooperatively interactive latching structures 24c, 26c, respectively, formed appropriately on the respective associated handle portions, and (d) a clamping nip region 22a which is located in the zone that lies between the two clamping pads.

The specific structural features of the just above-mentioned handle portions and latching structures form no part of the present invention. They may be made in any suitable, conventional way, and two of these ways are shown in the drawing figures herein.

Clamping pads 24b, 26b, also referred to herein as matchingly grip-patterned clamping pads, however, are quite unique in construction. As can be seen, these two clamping pads include faces 24d, 26d which confront one another on opposite sides of nip region 22a, and which faces are grip-patterned three-dimensionally herein by a plurality of projection-and-relief elongate ridges and intermediate valleys (projection-and-relief configurations), as can be seen very clearly in FIGS. 11 and 12. In FIG. 1, these specially grip-patterned regions of the clamping pads are identified with the reference characters 24d, 26d.

With respect to each of clamping pads 24b, 26b, and the confronting faces thereof which define nip region 22a, and referring now especially to FIGS. 11 and 12, where clamping pad 24b and its patterned face 24d are clearly illustrated, the mentioned, associated, three-dimensional projection-and-relief configuration includes elongate, grid-patterned orthogonal ridges, or projection structures, such as those shown at 34, giving clamping pad face 24d a kind of waffle-pattern appearance. Formed appropriately in those ridges which generally parallel previously mentioned axis 20a are three, generally laterally extending rows 36, 38, 40 of plural, aligned slots, such at the slots shown at 42. These slots face generally upwardly in FIGS. 11 and 12. The functionality of these slots will be explained shortly.

Further included in this patterning configuration is a central socket, or well, 44 which is generally rectangular in configuration, and which is defined, at least in part, by central end regions, such as those shown at 34a in FIG. 12, in the central pair of ridges 34 which generally parallel previously mentioned axis 28a.

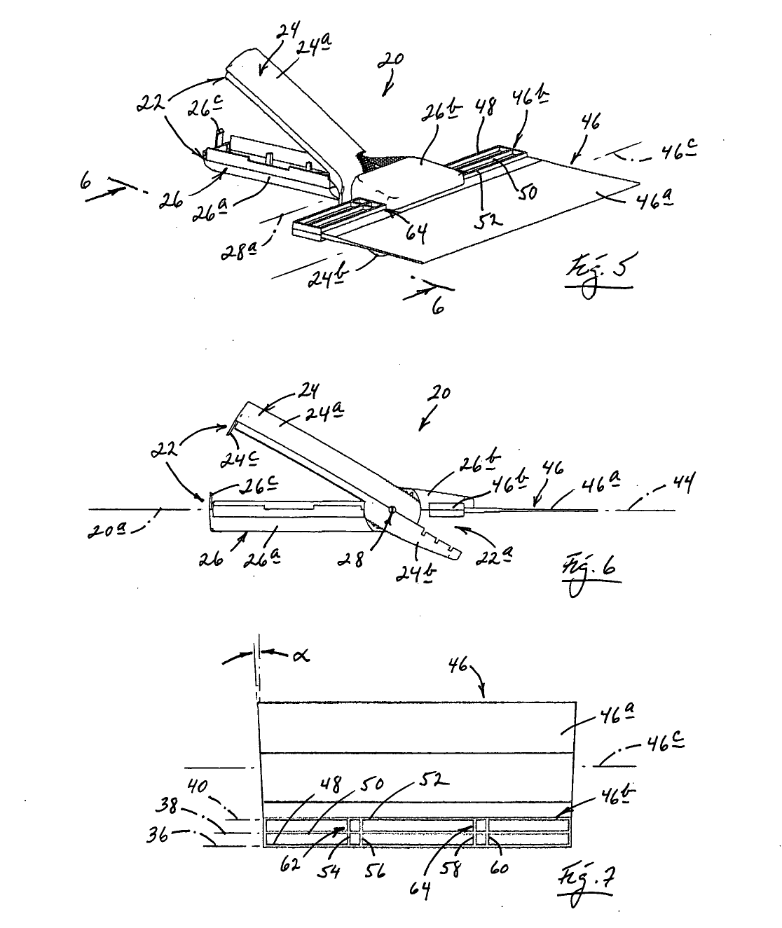

Completing a description of handle components 24, 26, and referring with pointed specificity to FIG. 4 in the drawings in the context of the other drawing figures, the two handle components are exact molded duplicates of one another in the preferred embodiment of the invention which is now being described. Such a condition, of course, greatly simplifies mold manufacturing. As will be observed, and focusing for a moment only on a single one of the handle components, each such component can be characterized as possessing no plane of bilateral, axial symmetry relative to any axis. However, when the two handle components are pivotally assembled to complete handle structure 22, the combined assembly indeed possesses what is referred to herein as substantial, orthogonal, mirror-image, bilateral symmetry in substantially all planes containing axis 20a. This kind of symmetry is that which one would observe on opposite sides of a bisecting plane containing axis 20a by projecting the structural image which exists on one side of that plane toward the reflective sides of a pair of orthogonally disposed mirrors which meet along a line that substantially parallels axis 20a.

Further, and now looking specifically at FIG. 4 in the drawings, from the point of view of system 10 pictured there, one can see that handle components 24, 26, and clamping pads 24b, 26b, are disposed, effectively, on opposite sides of a plane 44 which contains axis 20a. This plane is referred to herein as a shared plane, and as system 20 is illustrated in FIG. 4, the two handle components are said to be substantially co-planar in this shared plane. Because of the coincidence of axis 20a and plane 44, the dash-dot line shown I FIG. 4 is labeled both 20a and 44. As can be seen, and with respect to each of the individual handle components, the handle portion thereof lies effectively on one side of plane 44 and clamping pad portion lies on the opposite side of this plane.

Finally, it should be observed and understood that handle components useable to make up handle structure 22 in accordance with practice of the present invention may be made with different specific features, such as different lengths. A relatively short handle structure is pictured in FIGS. 2-6, inclusive. A longer handle structure (pictured for one of the handle components only) is illustrated in FIG. 8. Other variations, which do not depart from the main features of the invention, may also be made in the specific configurations selected for the handle structure components.

With pivoting of the two handle components about axis 28a, nip region 22a is opened and closed so as to enable cooperative interengagement with the other main component in system 20 which is now to be described.

This other main component is an elongate, generally planar blade 46 which is somewhat trapezoidal in perimetral outline, as can clearly be seen in FIGS. 3, 7 and 10, and includes an elongate working body portion, or body, 46a joined to an elongate, perimeter-edge-patterned spine 46b. In these three figures, the trapezoidal, perimetral outline of blade 46 is seen especially well, as illustrated by the small angle α.

As can be seen relatively well in FIGS. 4 and 6, when blade 46 is correctly oriented relative to handle structure 22, the nominal plane of the blade component substantially lies in previously mentioned plane 44. With regard to this plane, blade 46 is bilaterally symmetric with respect to opposite sides of the plane. In other words, opposite, broad, facial views of the opposite faces of blade 46 look the same from opposite sides of the blade. The long axis 46c of blade 46 lies at an oblique angle (herein 90°) relative to axis 20a.

Preferably, blade 46 is molded from a suitable plastic material, such as polycarbonate Lexan®.

Focusing attention for a moment on the construction of patterned spine 46b which, as was just suggested, has essentially the same configuration on opposite sides of blade 46, this spine is prepared, on its opposite sides, or faces, with what are referred to herein as complementary, projection-and-relief patterning configurations intended to permit positive, change-position, releasable locking between blade 46 and handle structure 22. Such locking is referred to herein as positive-lock, universally-invertible, plural-position clamp locking. The spine's patterning configurations are also referred to herein as matchingly grip-patterned clamping sites.

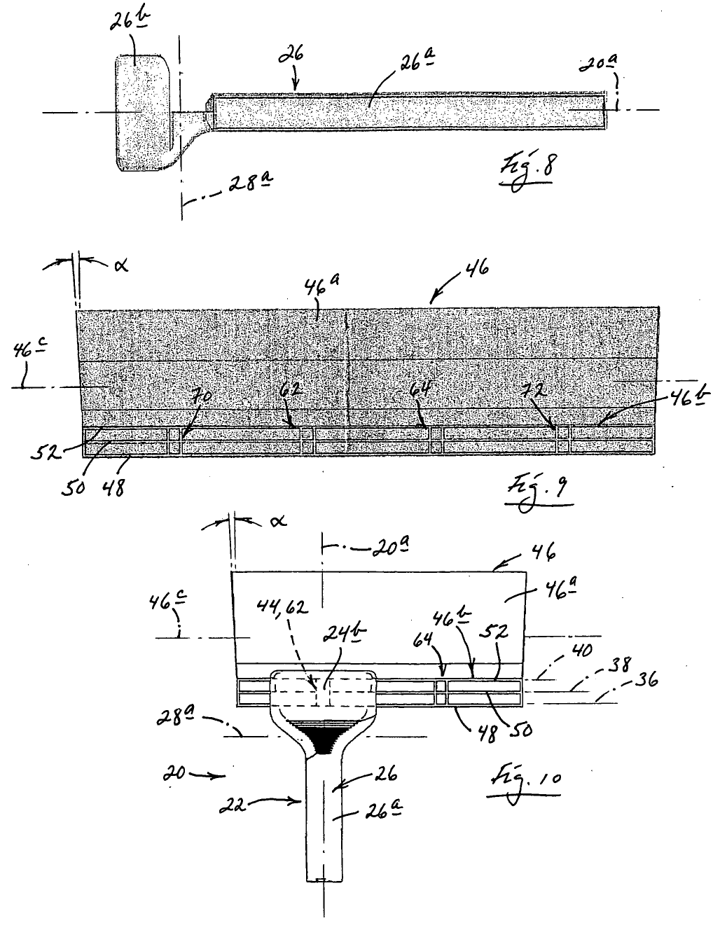

Looking especially now at FIG. 7 in the drawings, and describing that portion of spine 46b which faces the viewer in this figure, this spine includes three, elongate, projecting ridges 48, 50, 52 which are spaced apart, are generally parallel to one another, and are also generally parallel long axis 46c of blade 46. Ridges 48, 50, 52 are compatible with, and are intended to fit generally in a clearance-fit manner within, previously mentioned clamping-pad slots 42 on opposite sides of blade 46 when the blade is assembled (i.e., clamped by and with) handle structure 22. In FIG. 7, ridges 48, 50, 52 are shown, in a schematic sense, aligned with previously mentioned lines 36, 38, 40 which are the lines (see FIG. 12) which define the lateral, linear alignment of the several slots 42 provided in each clamping pad.

Completing a description of blade 46 as it appears in FIG. 7, and specifically of spine 46b as it appears on opposite sides of this blade, included in the projection-and-relief structure which provides patterning for spine 46b are short projecting ridges 54, 56, 58, 60 which, together with ridges 48, 50, 52, form two, laterally spaced, rectangular configurations 62, 64 which play a special role in predefining certain different relative translational positions that may be assumed between handle structure 22 and blade 46 when these two structures are assembled. More will be said about this shortly. When it is desired to prepare system 20 for use, the pivoted handle components in handle structure 22 are adjusted so as to separate clamping pads 24b, 26b, thus to open nip region 22a as seen in FIGS. 1, 5 and 6. Blade 46 is then inserted into the nip region, as illustrated by an arrow 66 in FIG. 1, generally in a direction generally paralleling axis 20a, and to a point where closure of the clamping pads upon opposite sides of spine 46b will cause appropriate locking interengagement to take place between the patterning configurations in the two clamping pads on opposite sides of the patterning configurations (clamping sites) provided by blade spine 46b.

Assuming that blade 46 is intended to be laterally centered with respect to axis 20a, the blade is so inserted, and the handle structure is adjusted to bring the claming pads into clamping and locking engagement with the blade to produce a clamped and locked condition, such as that shown in FIGS. 2-4, inclusive. Under this condition, elongate ridges 48, 50, 52 on opposite sides of spine 46b are received in slots 42 in the clamping pads, and rectangular configurations 62, 64 in spine 46d lie closely adjacent the opposite lateral sides of the clamping pads, as can be seen especially well in FIGS. 2, 3 and 5, to define a stabilized, locked, lateral condition between blade 46 and handle structure 22.

With this condition established, the latching mechanisms in the handle components releasably lock the handle in a clamping condition, and as a consequence, the handle structure and blade are prevented any relative motion with respect to one another. It will be noted that, because of the constructions described for the clamping pads and for the blade spine structure, it makes no difference which condition of relative inversion exists between the handle structure and the blade in terms of assembling these two components for use. A difference in relative inversion positions is suggested in FIG. 1 by a double-headed curved arrow 68.

Describing now certain other important features of the system of this invention, it is possible to change the working relationship between the handle structure and the blade. It is also possible to use differently sized and configured handle structures and blades.

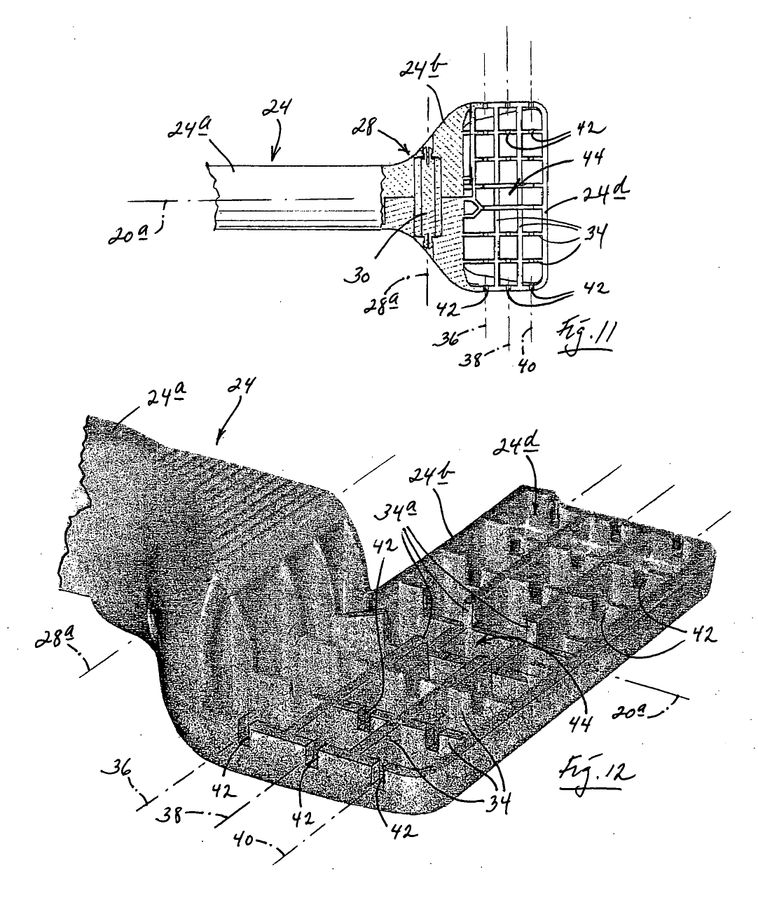

Beginning with an illustration of the former—i.e., a relative working relationship change—if it is desired to readjust the relative translational positions of the handle structure and the blade within shared plane 44, for example, to produce a condition such as that shown in FIG. 10 where the blade is laterally offset to the right of axis 20a in this figure, clamping is accomplished in a manner whereby one opposite pair of rectangular configurations 62, 64 in the blade spine become received within wells 44 provided in the patterning configurations in the clamping pads. In FIG. 10, configurations 62 in spine 46b are so received.

Such a lateral readjustment of blade 46 relative to handle structure 22 is indicated very generally and schematically by a double-headed, linear arrow 70 in FIG. 1, wherein, in dashed lines, the laterally centrally shown solid-outline blade is shown laterally offset in the same manner illustrated for the blade in FIG. 10. The amounts and directions of such lateral shifting to predetermined lockable conditions between the handle structure and the blade are matters of designer choice, to be implemented by appropriate reconfigurations of the patterning layouts provided in these two main components of the invention.

With respect to size changing, two different-length handle structures have been mentioned above. Blade size and configuration may also be varied. For example, in dash-triple-dot lines in FIG. 1, an alternative blade is shown which has a length greater than that of the blade pictured in solid outline in this figure. Such an alternative-length blade herein might take the form of the long blade 46 shown in FIG. 9 in the drawings. This longer version of blade 46, seen in plan view from one broad side in FIG. 9, includes, generally speaking, the same kind of working body portion 46a as was mentioned earlier, and the same general spine structure 46b, except that because of the greater length of this blade, the spine structure includes two additional spaced rectangular patterned formations 70, 72 provided to accommodate several different laterally differentiated and locked position possibilities relative to handle structure 22. Formations 70, 72 are like previously described formations 62, 64.

Not specifically illustrated in the drawings is yet the further possibility of changing the perimetral shape of a blade to suit special use conditions. This might, of course, be especially relevant to adapting the invention for use in fields other than the “taping mud” field. Illustrations of such other fields of utility include, for examples, the field of various garden tools, the field of various squeegee tools, and the field of various scraper tools, as well as many others wherein spatula-like tool implements are typically employed.

Thus the tool system of the invention proposed offers a number of interesting and important features and advantages in applications where a spatula-like tool is to be employed. And, while a specific set of embodiments of the invention have been described herein for use especially in the particular field of applying so-called taping mud, other fields of use may benefit just as well from having a component system as illustrated and described.

The system of the invention obviously offers a great deal of flexibility and versatility, and enables a user effectively to have a large family of different tools with only a relatively few components. Blade and handle structure assemblies are connectable and disconnectable freely and quickly at will to accommodate a user's need to have different blade and/or handle structure styles to suit specific tasks. If a blade for some reason becomes worn or damaged beyond practical use, a new blade may easily be substituted without requiring a user to acquire an entire, new, stand-alone tool.

The tool system of the invention is easily formed of relatively inexpensive plastic materials, and because of its component nature, and as stated above, can provide a user with a relatively wide range effectively of different tools without requiring the expenditure of a large collection of individual “free standing” tools.

Accordingly, while a preferred embodiment, and several variations and modifications, of the invention have been illustrated and described herein, it is appreciated that other variations and modifications may be made without departing from the spirit of the invention.

We claim:

1. A component spatula tool system comprising
an elongate grip handle structure, and
a generally planar blade releasably grippable by said handle structure

2. The system of claim 1 which is structured in such a manner that said blade is releasably grippable by said handle structure in plural, different, predetermined positions relative to the handle structure.

3. The system of claim 2, wherein said different predetermined relative positions include (a) different relative translational positions between said handle structure and said blade generally within a shared plane containing these two components, and (b) different positions of relative inversion between the handle structure and the blade in relation to the opposite sides of the shared plane.

4. The system of claim 2, wherein each of said different predetermined relative positions is characterizable as one creating a positively, yet releasably, interlocked condition between said handle structure and blade.

5. The system of claim 1 which is designed for use in the field of applying taping mud.

6. A component spatula tool system comprising
handle structure having a pair of opposed, selectively openable and closeable, matchingly grip-patterned clamping pads that define a nip region, and
a blade having opposite sides possessing matchingly grip-patterned clamping sites whose grip patterns are complementary to those of said clamping pads,
said clamping pads and said clamping sites accommodating, via operative interengagements of their respective grip-patterned characteristics, positive-lock, universally invertible, plural-position clamp locking of said blade within said nip region.

7. A component spatula tool system comprising
a blade including an elongate working body and an elongate patterned spine,
an elongate, articulated handle structure including openable and closeable, positive-lock clamping structure patterned to be lockably complementary to the spine, operable for releasable positive-lock gripping of said blade via said spine.

8. The system of claim 7, wherein said blade and handle structure each has a long axis, said clamping structure is disposed adjacent one end of said handle structure, and said handle structure and said blade are disposed with their respective long axes oriented at an oblique angle relative to one another under circumstances with said clamping structure gripping said blade.

9. The system of claim 8, wherein said oblique angle is substantially a right angle.

10. The system of claim 7, wherein said clamping structure includes a pair of opposed, relatively moveable clamping pads having confronting faces including confronting projection-and-relief configurations which form the patterning in the clamping structure, said spine includes a pair of opposite, outwardly facing faces including projection-and-relief configurations which form the patterning in the spine, and the mentioned positive-lock gripping between said blade and said clamping structure occurs through engagement between said protection-and-relief configurations.

11. The system of claim 7, wherein said blade and said clamping structure become generally co-planar in a shared plane with the latter positively lockably gripping the former, and under such a circumstance, the blade and the clamping structure are positively denied motion relative to one another within their generally shared plane.

12. The system of claim 7, wherein said spine and said clamping structure are furnished with releasably inter-engageable projection structures which permit, with opening and closing of said handle structure, releasable and lockable relative repositioning between the spine and the clamping structure so as to enable disposition of the blade and the handle structure selectively in different positions relative to one another.

13. The system of claim 7, wherein said handle structure includes a pair of duplicate-shape, reversely disposed handle components.

14. The system of claim 13 which has a long axis, and wherein said handle components, in their condition of reverse disposition in said handle structure, collectively possess a substantially infinite number of planes of substantially orthogonal-mirror-image bilateral symmetry, with all such planes containing said long axis.

15. The system of claim 7, wherein each handle component lacks any plane of bilateral symmetry.

16. The system of claim 7, wherein said blade and said handle structure are formed each of a molded plastic material.

17. The system of claim 7 which further includes at least one additional blade having an overall configuration that differs from that of the first-mentioned blade.
